(19) United States
(12) Patent Application Publication
(10) Pub. No.: US 2005/0165720 A1
(43) Pub. Date: Jul. 28, 2005

(54) Modular assembly of software and method of configuring same

(76) Inventors: Thomas McKeown, Oxford, MI (US); Jason Randall, Shelby Township, MI (US); Jay Miller, Rochester Hills, MI (US); Brian Matuszak, Richmond, MI (US); Venkata Klk Vadlamudi, Rochester, MI (US); Robert Markevics, Rochester, MI (US)

Correspondence Address: David J. Simonelli, Esq.;Clark Hill PLC, Suite 3500, 500 Woodward Ave., Detroit, MI, 48226-3435, US

(21) Appl. No.: 10/765,290

(22) Filed: Jan. 27, 2004

(51) Int. Cl. G06F 7/00

(52) U.S. Cl. 707/1

(57) ABSTRACT

A modular assembly of software is configured to perform a particular function. The modular assembly includes a plurality of atoms. Each of the plurality of atoms is designed to execute a defined task. The modular assembly also includes a plurality of maps that invoke a portion of the plurality of atoms allowing for the execution of events that include a portion of the defined task. The modular assembly also includes a map engine that is in communication with each of the plurality of maps. The map engine coordinates an order and timing for the starting of each of the plurality of maps wherein the map engine modifies the order and the timing based on the inputs and variables received thereby before and during the operation of the plurality of maps. Each of the plurality of atoms are defined sets of code, e.g., objects. These atoms each include a design element classifying a type of executable, identifying inputs required to operate the executable and identifying a purpose of the atom. In addition, each of the plurality of atoms includes an execution element that executes the defined task.

### BACKGROUND ART

1. Field of the Invention

The invention relates to the field of software system architecture. More particularly, the invention relates to a modular software system architecture allowing for the ease in construction and modification of complex software systems.

2. Description of the Related Art

Manufacturers are increasingly relying on software systems for the shop floor to streamline processes that occur on the shop floor. By way of example, such processes include production validation, demand synchronization, lot traceability, production in non-conformance reporting, and the like. In order to maintain competitive advantages and profitability, manufacturers are forced to evolve over time based on the demands of their customers and to accommodate process improvement initiatives.

Manufacturers have many processes whose performance is not maximized. These processes are not maximized because of several reasons. For those reasons that are related to software implementation, the reason for under performance may include the fact that a certain piece of software was created for a particular process, which has subsequently become obsolete. Not wanting to increase additional costs with modifying the software, the manufacturer continues to operate along the parameters outlined by the software because it is too difficult to change the architecture of the software. A second instance where a manufacturer is including software in its processes that under performs its potential is when a manufacturer purchases a generic “off the shelf” piece of software that has minimal capabilities of being modified. In this instance, the manufacturer is forced to potentially build inefficiencies into its processes just so that the software will operate in the environment of the shop floor of the manufacturer. These instances prevent a manufacturer from easily changing software architecture based on the needs of its customers and the products it is producing.

An example of a software architecture that attempts to alleviate the problems set forth above is disclosed in U.S. Pat. No. 5,398,336, issued to Tantry et al. on Mar. 14, 1995. This patent discloses an object-oriented architecture for a factory floor management software system. If this system were used, it would be a large step toward maximizing the efficiencies of a manufacturer in the operations of its shop floor. In this system, the architecture includes a plurality of application engines wherein each includes a separate process which contains, at a minimum, an event handler in some application-specific code. Each application engine also contains non-reusable application-specific code that maintains the application context/state and creates application service requests.

The problem with the architecture as disclosed in the above-identified reference is that it is difficult to modify the architecture of the software once it is put in place. While nodes can be added to the architecture as the complexity of the processes on the shop floor increase, the nodes that exist within the system are not easily modifiable and are difficult to update as new requirements are introduced into the system.

### SUMMARY OF THE INVENTION

A modular assembly of software is configured to perform a particular function. The modular assembly includes a plurality of atoms. Each of the plurality of atoms is designed to execute a defined task. The modular assembly also includes a plurality of maps that invoke a portion of the plurality of atoms allowing for the execution of events that include a portion of the defined task. The modular assembly also includes a map engine that is in communication with each of the plurality of maps. The map engine coordinates an order and timing for the starting of each of the plurality of maps wherein the map engine modifies the order and the timing based on the inputs and variables received thereby both before and during the operation of the plurality of maps. Each of the plurality of atoms are defined sets of code, e.g., objects. These atoms each include a design element classifying a type of executable, identifying inputs required to operate the executable and identifying a purpose of the atom. In addition, each of the plurality of atoms includes an execution element that executes the defined task.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a schematic view of an environment in which the invention would operate;

FIG. 2 is a scaled embodiment in which the invention would operate;

FIG. 3 is a schematic view of the architecture for the invention in an enterprise-wide deployment;

FIG. 4 is a schematic view of the relationship between the map engine, maps, and atoms within maps;

FIG. 5 is a schematic view of how a map engine interacts with an atom;

FIG. 6 is a schematic view of an atom;

FIG. 7 is a schematic view of a plurality of maps; and

FIG. 8 is a representation of a screen showing the different levels of the invention in operation.

### DETAILED DESCRIPTION OF THE PREFERRED EMBODIMENT

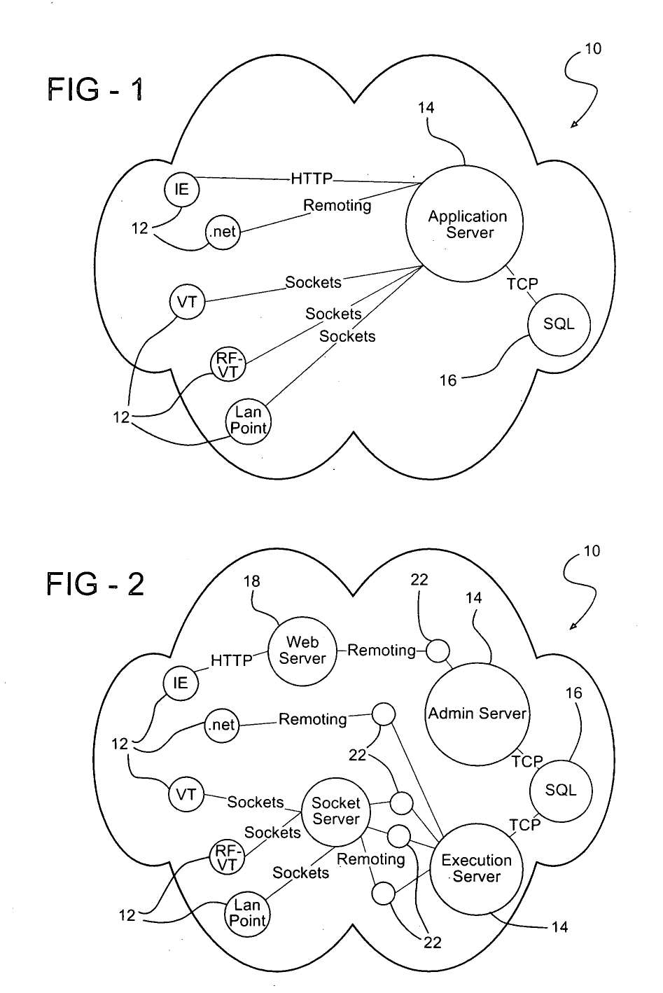

Referring to FIG. 1, a modular assembly of the software in its most basic configuration is generally indicated at 10. The modular assembly of software 10 is designed to promote such characteristics as flexibility, adaptability, inner operability, performance, and scalability in order to easily accommodate companies that continue to reinvent their business processes, whether they are on the shop floor or in a retail outlet. At its most fundamental level, the modular assembly of software 10 is a three-tiered application which includes presentation elements or clients 12, an application server 14 and a database 16. The presentation elements 12 are client types and present information and events to the application server 14. The application server 14 utilizes the information presented by the presentation elements 12 and the data found on the database 16 to operate. Example of presentation elements include internet explorer, .net, a LAN point, and the like.

The tiered architecture shown in FIG. 1 enables virtually any client type to be used as a presentation element 12 which will interact with the application server 14. The system is designed to be hardware independent to facilitate the communication between various pieces of hardware that may be required to complete a task. The flexibility is also applied to the user interface to form a web-accessible configuration, reporting and administration tools.

With regard to the database 16, this tiered approach results in a data store independent solution. The modular assembly of software 10 results in a cost effective database solution that is ANSI SQL compliant.

Further, with the isolation of the application server 14 from the presentation elements 12 and the database 16, a consolidation occurs in the business logic such that the business logic is stored into a single repository instead of being stored in procedures or separate executables that traditionally impede change initiatives or adversely effect quality, due to code redundancies and application mismanagement. With the modular assembly of software 10, object oriented programming principles are used to segregate code into small units of functionality. This method eliminates the need for systematic releases of new functionality, which would include changes to the application server 14, and enhances performance by efficiently streamlining the application code that is transversed during run time. More importantly, this approach ensures that change requests from one customer will not interfere with the functionality of a different customer or user group. This eliminates the “work around” syndrome typically prevalent in software solutions. This reduces costs and decreases downtime for reconfigurations of systems.

Referring to FIG. 2, the modular assembly of software 10 has grown. In FIG. 2, identical reference characters represent similar elements as those found in FIG. 1. In this arrangement, the presentation elements or clients 12 are connected to the application servers 14 through a web server 18 and a socket server 20. In addition, a layer of server side client agents 22 allow remoting between the web server 18, the socket server 20 and the application servers 14. In FIG. 2, there are two application servers 14, they being the administration server 14 and the execution server 14. Both of these servers 14 are tied directly to the database 16.

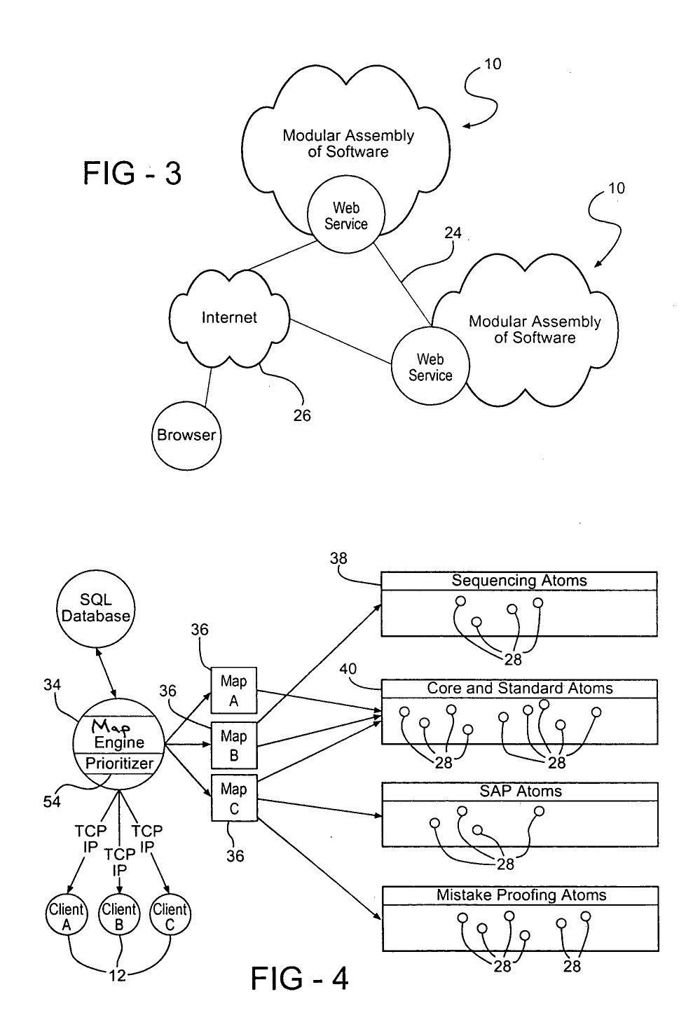

Continuing with the discussion of growth, the modular assembly of software 10 can be extended into an enterprise-wide system, as shown in FIG. 3. A facility using the modular assembly of software 10 could directly communicate with another facility using the modular assembly of software 10. This could be done through dedicated lines 24 or, as shown in FIG. 3 through the internet 26. This would allow the modular assembly of software 10 access to see such things as real time part consumptions as well as the ability to notify when shipments have been sent and/or received. As discussed above, the modular assembly of software 10 can communicate using direct lines 24.

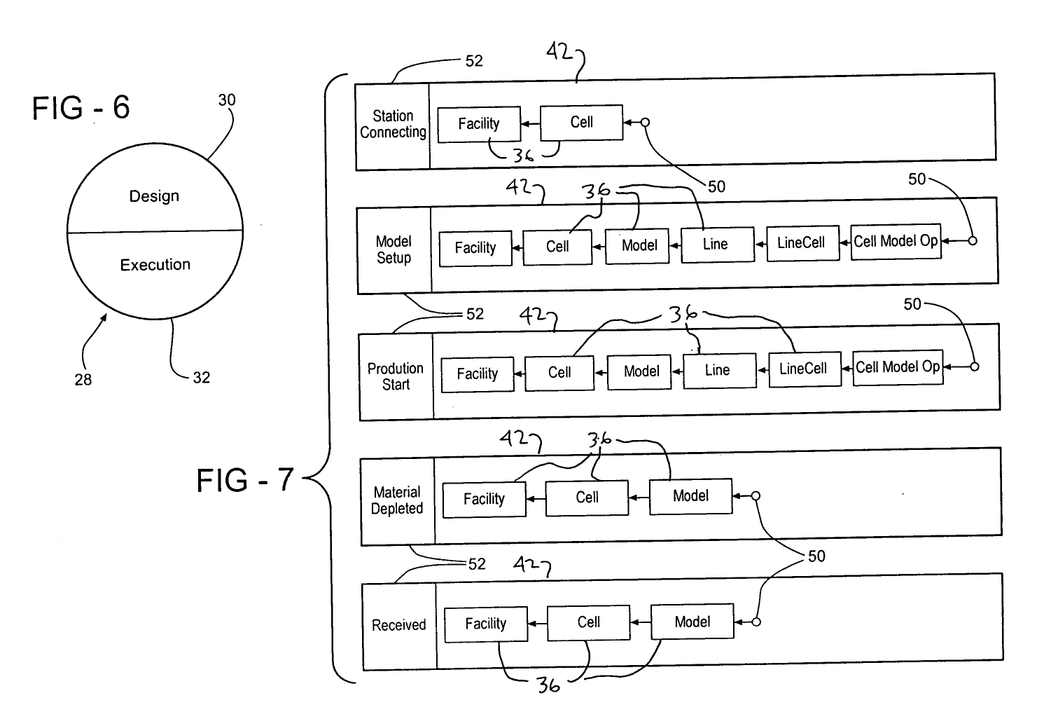

Referring to FIG. 6 an atom is generally indicated at 28. The modular assembly of software 10 is configured to perform a function. The modular assembly of software 10 includes a plurality of atoms 28. Each of these plurality of atoms 28 are designed to execute a defined task. A particular task may include identifying when materials have arrived, recording cycle times for the production of a part, taking measurements of temperatures, and the like. Each atom 28 receives inputs and performs an executable (or a number of executables) to or based on the inputs. The input may be an event or data. In one sense, nothing enters the modular assembly of software 10 that is not enveloped in an atom 28.

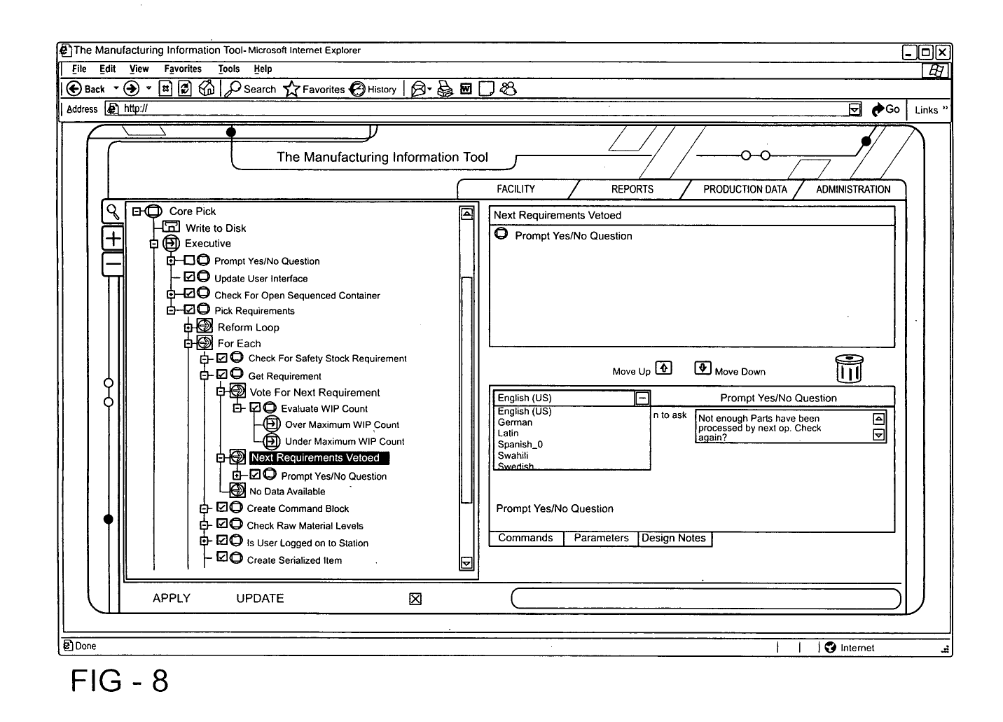

Each atom 28 includes two components. A first component 30 is a design element of the atom. The design element 30 describes what purpose the atom 28 has. It also identifies the type of command that the atom 28 includes. The design element 30 also includes the business rules for the command to operate properly and identifies the information required from a user at the moment that this atom 28 is invoked. The parameters of the business rules are provided via a web-based map designer (FIG. 8).

A second component of the atom 28 is the execution element 32. The execution element 32 uses the design time parameters to control the behavior of the atom 28 and performs the defined task. By the atom 28 including both design and execution characteristics in its design element 30 and its execution element 32, respectively, the atom 28 goes beyond a standard object in an object-oriented architecture for software. By creating an atom 28 that includes the design element 30, the atom 28 can be placed anywhere within the modular assembly of software 10 and it can operate properly so long as it has the required inputs to operate correctly. It is contemplated that the invention will be provided to customers with a suite of atoms 28 already created and ready to be used in particular places or situations identified by the customer based on the needs of the customer. In addition, unique atoms 28 may be created to perform functions specific to a particular customer's requirements. The modular assembly of software 10, provides all of the atoms with an identical structure allowing each of these atoms 28 to be interjected into any functional step needed by a customer in order to create a defined task wherein the defined task is completed in the order best defined by the business procedures of the customer.

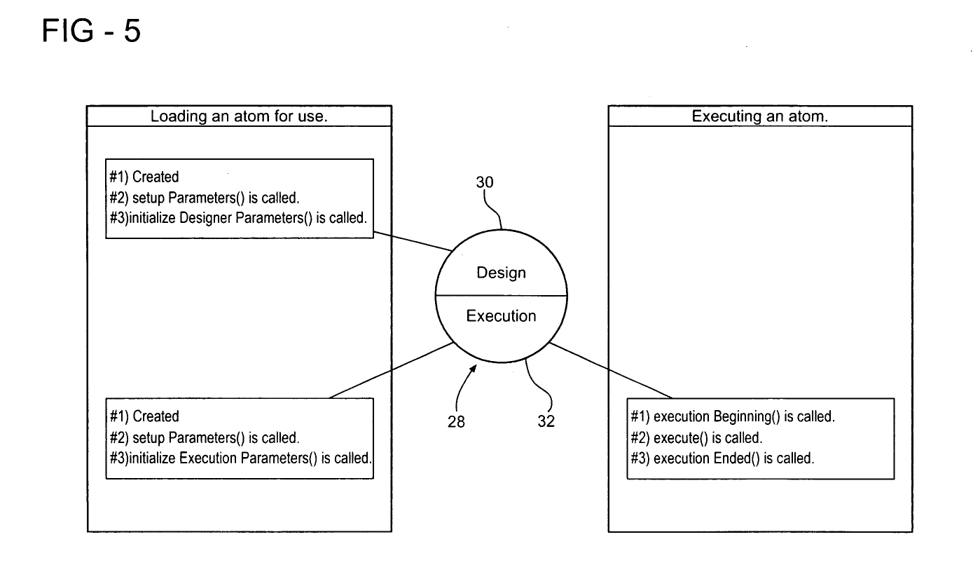

Referring to FIG. 5, an atom 28 is shown operating within the context of the modular assembly of software 10. An atom 28 is loaded for use. Parameters are called and initialized by communicating with the design element 30 of the atom 28. In addition to the loading of the atom 28 for use, the execution element 32 is called to have the parameters set up and initialized. Once this is completed, the execution element 32 begins the execution of the defined task and the output is transmitted to the appropriate component for use, analysis or viewing.

Referring to FIG. 4, a more detailed schematic of the architecture for the modular assembly of software 10 is shown. Clients A, B and C are clients or presentation elements 12. Clients A, B and C 12 represent different users that may require different information or are required to input different information at varying times through the cycle of the function. The modular assembly of software 10 also includes a map engine 34. The map engine 34 is a part of the application server 14. The map engine 34 is the link between each of the clients 12 and the modular assembly of software 10. The map engine 34 will be described in greater detail below.

The modular assembly of software 10 also includes a plurality of maps 36. The plurality of maps 36 invoke a portion of the plurality of atoms 28 for executing events that include a portion of the defined task. Maps 36 are used to coordinate the activity of each of the atoms 28. As may be seen in FIG. 4, the maps 36 point to particular groups of atoms 28 allowing each of the atoms 28 to execute at a specific time in relation to other specific atoms 28 that have been executed. By way of example, there are four groups of atoms 28 in FIG. 4. The first is sequencing atoms 38. This, coupled with a second set of atoms 40, the core and standard atoms, make up the set of atoms that are going to be invoked by the map 36 that is in the middle of the three maps 36 shown in FIG. 4. Likewise, a map 36 that is above the other two maps 36 and simply invokes the second set 40 of atoms 28 relating to the core and standard atoms. When a new defined task is required, a new atom 28 is simply added to a particular sequence or set of atoms 28. Then when the map 36 invokes that series of atoms 28, a new defined task will be performed. This is done without changing the maps 36 or the map engine 34. By changing the number or order of atoms 28 being executed without having to change the map engine 34 or the maps 36, upgrades and changes to the modular assembly of software 10 is done easily.

Referring to FIG. 7, a number of system maps 42 are shown with a plurality of maps 36 found therein. System maps 42 are a collection of maps 36 that are used to perform a function. The maps 36 shown in each of the system maps 36 are considered objects of each of the events 50.

The events 50 are represented by circles to the right of each of the sequences of atoms 28. The event 50 is the starting point of the system map 42. Each event 50 is some input or some condition met. These events 50 are types of atoms 28 and combine with the system maps 42, which include maps 36 and atoms 28, to create event modules 52. All of the event modules 52 combine to perform a function. Each of the maps 36, from right to left, all perform the same function. If a function cannot be done immediately with the map 36 to the right, the map engine 34 move the process to the left and invokes the next map 36 to have the defined task performed. Again, if the defined task cannot be performed at that level, it moves to a broader scope by moving to the right and invoking the next plan 36 in the system plan 42. Once the defined task is accomplished, the system plan 42 send the result to the desired location for output or further processing.

This approach of having events 50 related to specific atoms 28 removes the typical sequential, waterfall approach that is an inherent property in traditional software solutions. This new approach introduces a business process definition that is driven by the input parameters of the system or the outcome of certain events 50. Exceptions to defined tasks and events are easily addressed with this system.

As stated above, the each piece of information, be it an executable or an input enters the modular assembly of software 10 as an atom 28. By having the design element 30 and the executable element 32 always together, the modular assembly of software 10 will be able to act on that information regardless of where or when it appears in the procedure. As an example, one atom 28 may be used to receive an input value, e.g., a name of a user. Because the atom 28 includes a design element 30, the atom 28 knows what type of information it is to receive. Additionally, the atom 28 has the executable element 32 that may, for example, act on that data by sending it to a map 36 that relates to permissions. Regardless of the action being taken or the input being received by the modular assembly of software 10, it is always wrapped in an atom 28 allowing another atom 28, map 36 or system map 42 to eventually act on that information to further the defined task and, hence, the overall function being accomplished.

Referring to FIG. 8, a screen shot of the modular assembly of software 10 is shown. This first line of this screen on the left hand side, “Core Pick,” is a map 36. The map contains a plurality of atoms 28 which extend down through the tree of activities that are possible when the map 36 is selected. Each of the atoms 28 that have a check mark next to them identifies an atom 28 that is going to execute when the core pick plan 36 is selected. As may be appreciated by those skilled in the art, any number of atoms 28 may be added to the map 36 in any order desired by an operator of the modular assembly of software 10.

Returning attention to the map engine 34, the map engine 34 is in communication with each of the plurality of maps 36. The map engine coordinates an order and timing for the starting for each of the plurality of maps 36 wherein the map engine 34 modifies the order and the timing based on inputs and variables received by the map engine 34 before and during the operation of the plurality of maps 36. The map engine 34 includes a prioritizer 54. The prioritizer 54 identifies the order and the timing of the execution of each of the plurality of maps 36 and each of the plurality of atoms 28. The prioritizer 54 includes input lines which receive inputs from clients 12 that may change the order and the timing of the execution of each of the plurality of maps 36.

In operation, the method of performing a function using the map engine 34, the plurality of maps 36 and the plurality of atoms 28 includes the step of activating the map engine 34. Once the map engine 34 is activated, it catalogs each of the plurality of atoms 28 so that the map engine 34 has an accurate inventory of the plurality of atoms 28 available. The map engine 34 then identifies the occurrence of an event 50. It then associates the event 50 with one of the plurality of maps 36. One of the plurality of maps 36 is loaded. This is the map 36 that is associated with the event 50. Each of the atoms 28 in that particular map is then executed such that the function to be performed is done in response to the occurrence of the event 50. Should a need for a change in a function or defined task be identified by a user of the modular assembly of software 10, the plurality of atoms 28 may be changed based on that identified need for a change in the function to be performed. Likewise, the plurality of maps 36 associated with a particular function may be changed if there is an identified need for the change in the plurality of maps 36. Most importantly, these changes may be made independently of each other and without touching the map engine 34. Inherent in changing either the atoms 28 or the maps 36, is the ability to change the order in which any of the atoms 28 or maps 36 are executed.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A modular assembly of software configured to perform a function, said modular assembly comprising:
a plurality of atoms, each of said plurality of atoms designed to execute a defined task;
a plurality of maps invoking a portion of said plurality of atoms for executing events that include a portion of said defined task; and
a map engine in communication with each of said plurality of maps, said map engine coordinating an order and a timing for starting of each of said plurality of maps, wherein said map engine modifies said order and said timing based on inputs and variables received thereby before and during operation of said plurality of maps.

2. A modular assembly as set forth in claim 1 wherein said map engine includes a prioritizer to identify said order and said timing of execution of each of said plurality of maps and each of said plurality of atoms.

3. A modular assembly as set forth in claim 2 wherein said prioritizer includes input lines which receive inputs from clients that may change said order and said timing of execution of each of said plurality of maps.

4. A modular assembly as set forth in claim 3 wherein each of said plurality of atoms includes a design element classifying a type of executable, identifying inputs required to operate the executable and identifying a purpose therefor.

5. A modular assembly as set forth in claim 4 wherein each of said plurality of atoms includes an execution element that executes said defined task.

6. A modular assembly of software configured to perform a function, said modular assembly comprising:
a plurality of atoms designed to execute a plurality of tasks, each of said plurality of atoms including a design element and an execution element such that each of said design elements identifies a type of executable, inputs required by each of said plurality of atoms and purpose therefor, and each of said execution elements execute said defined task;
a plurality of maps invoking a portion of said plurality of atoms for executing events that include a portion of said defined task; and
a map engine in communication with each of said plurality of maps, said map engine coordinating an order and a timing for starting of each of said plurality of maps, wherein said map engine modifies said order and said timing based on inputs and variables received thereby before and during operation of said plurality of maps.

7. A modular assembly as set forth in claim 6 wherein said map engine includes a prioritizer to identify said order and said timing of execution of each of said plurality of maps and each of said plurality of atoms.

8. A method of performing a function, including a plurality of defined tasks, using a map engine, a plurality of maps, and a plurality of atoms, each having design and executable elements, the method comprising the steps of:
activating the map engine;
cataloging each of the plurality of atoms so that the map engine has an accurate inventory of the plurality of atoms available;
identifying an occurrence of an event;
associating the event with one of the plurality of maps;
loading the one of the plurality of maps associated with the event; and
executing each of the plurality of atoms identified with the one of the plurality of maps such that the function to be performed is done in response to the occurrence of the event.

9. A method as set forth in claim 8 including the step of loading a plurality of maps, each being loaded in response to an identification of an event.

10. A method as set forth in claim 9 wherein the step of identifying an occurrence of an event includes the receipt of an input.

11. A method as set forth in claim 10 including the step of receiving the input into one of the plurality of atoms.

12. A method as set forth in claim 11 including the step of changing the plurality of atoms associated with the plurality of maps based on a change in the function to be performed.

13. A method as set forth in claim 12 including the step of changing the plurality of maps associated with function based on a change in the function to be performed.

14. A method as set forth in claim 13 wherein the step of changing the plurality of atoms includes changing the number of atoms being executed.

15. A method as set forth in claim 14 wherein the step of changing the plurality of maps includes changing the number of maps being invoked.

16. A method as set forth in claim 15 wherein the step of changing the plurality of atoms is performed independently of the step of changing the plurality of maps.

17. A method as set forth in claim 16 wherein the step of changing the plurality of maps is performed independently of the step of changing the plurality of atoms.

18. A method as set forth in claim 17 wherein the step of changing the plurality of atoms includes the step of modifying the number of the plurality of atoms being executed with one of the plurality of maps.

19. A method as set forth in claim 18 wherein the step of changing the plurality of atoms includes the step of modifying an order in which the plurality of atoms are executed within one of the plurality of maps.
